(19) United States
(12) Patent Application Publication
(10) Pub. No.: US 2013/0206821 A1
(43) Pub. Date: Aug. 15, 2013

(54) METAL BONDING METHOD

(71) Applicant: Sanyo Electric Co., Ltd., (US)

(72) Inventors: Koichi SAITO, Ogaki-shi (JP); Yoshio Okayama, Moriyama-shi (JP); Yasunori INOUE, Ogaki-shi (JP)

(73) Assignee: SANYO ELECTRIC CO., LTD., Osaka (JP)

(21) Appl. No.: 13/772,087

(22) Filed: Feb. 20, 2013

Related U.S. Application Data
(63) Continuation of application No. PCT/JP2011/005556, filed on Sep. 30, 2011.

(30) Foreign Application Priority Data
Sep. 30, 2010 (JP) 2010-222603

(51) Int. Cl. B23K 20/24

(52) U.S. Cl. CPC B23K 20/24
USPC 228/208

(57) ABSTRACT

After a first coating portion formed on a bonding face of a first bonding portion and a second coating portion formed on a bonding face of a second bonding portion are removed by reverse sputtering, copper sputtering is performed to form first and second copper films. The gap between the oxide film on the outermost face of the first copper film and the oxide film on the outermost face of the second copper film is filled with a solution into which copper oxide can be eluted, thereby eluting copper oxide contained in the oxide film in the solution. By applying pressure and heat, the components contained in the solution are removed except for copper, thereby bonding the outermost face of the first copper film and the outermost face of the second copper film to each other by means of copper solid-phase diffusion.

### BACKGROUND OF THE INVENTION

1. Field of the Invention

The present invention relates to a metal bonding method. Particularly, the present invention relates to a method for bonding metal members each of which has an oxide film formed on its surface.

2. Description of the Related Art

In conventional techniques, solder is used to electrically bond electronic components, e.g., to provide bonding portions which allow a semiconductor chip to be mounted on a wiring substrate. However, in a case of employing such solder, for example, to bond Cu members to each other, a Cu—Sn alloy layer occurs at a bonded interface between each bonding portion and the adjacent solder layer. Such a Cu—Sn alloy layer has relatively large electric resistance and poor ductility, leading to a problem of poor electric characteristics and/or a problem of poor connection reliability at such a bonding portion.

In order to solve such problems, Patent document 1 has disclosed a technique for bonding, via an intermetallic compound layer, a pair of electrodes that face each other.

### RELATED ART DOCUMENTS

### Patent Documents

[Patent Document 1]

Japanese Patent Application Laid Open No. 2002-110726

With such a bonding technique disclosed in Patent document 1, an intermetallic compound layer is formed using solid-phase diffusion. In general, an oxide film, which is a natural oxide film, is formed on the surface of a metal member. In a case in which a bonding technique using solid-phase diffusion is employed to bond metal members having an oxide film formed on their surface, such an oxide film impedes such diffusion, leading to difficulty in bonding, which is a problem. Furthermore, with such a bonding technique, a residual oxide film leads to a problem of poor electric connection reliability. In particular, an aluminum oxide film formed on the surface of an aluminum member is a very stable oxide film. Thus, such an aluminum oxide film leads to increased difficulty in bonding using such solid-phase diffusion, leading to a problem of poor electric connection reliability.

### SUMMARY OF THE INVENTION

The present invention has been made in order to solve such problems. Accordingly, it is a general purpose of the present invention to provide a bonding method which allows metal members each having an oxide film on their surface to be bonded with high strength in a simple manner.

An embodiment of the present invention relates to a metal bonding method. The metal bonding method comprising: preparing a first bonding portion containing, as a principal component, a metal component other than copper or an inorganic compound, and a second bonding portion containing, as a principal component, a metal component that is the same as or otherwise differs from the metal component that is a principal component of the first bonding portion; forming a copper film on an exposed face of the first bonding portion and on an exposed face of the second bonding portion; filling a gap between the copper film formed on the first bonding portion and the copper film formed on the second bonding portion with a material into which copper oxide can be eluted; and applying pressure to the first bonding portion and the second bonding portion so as to reduce the distance between them, thereby bonding the first bonding portion and the second bonding portion via copper.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A, 1B and 1C are process diagrams showing a metal bonding method according to an embodiment;

FIGS. 2A, 2B, 2C and 2D are process diagrams showing a metal bonding method according to an embodiment;

FIGS. 3A, 3B, 3C and 3D are process diagrams showing a metal bonding method according to an embodiment;

FIG. 4 is a diagram which shows a schematic configuration of a non-aqueous electrolyte secondary battery used as an application example 1 of the metal bonding method;

FIG. 5 is a cross-sectional partial disassembled perspective view showing a cylindrical secondary battery used as an example application 2 of the metal bonding method;

FIGS. 6A, 6B, and 6C are schematic process diagrams for describing the application example 2 of the metal bonding method;

FIGS. 7A, 7B, 7C, 7D and 7E are process diagrams showing a schematic configuration of a process according to a metal bonding method which is applied to bond a heat sink and a heat dissipation fin; and

FIGS. 8A, 8B and 8C are process diagrams showing a schematic configuration of a process according to a metal bonding method which is applied to bond a heat sink and a heat dissipation fin.

### DETAILED DESCRIPTION OF THE INVENTION

The invention will now be described by reference to the preferred embodiments. This does not intend to limit the scope of the present invention, but to exemplify the invention.

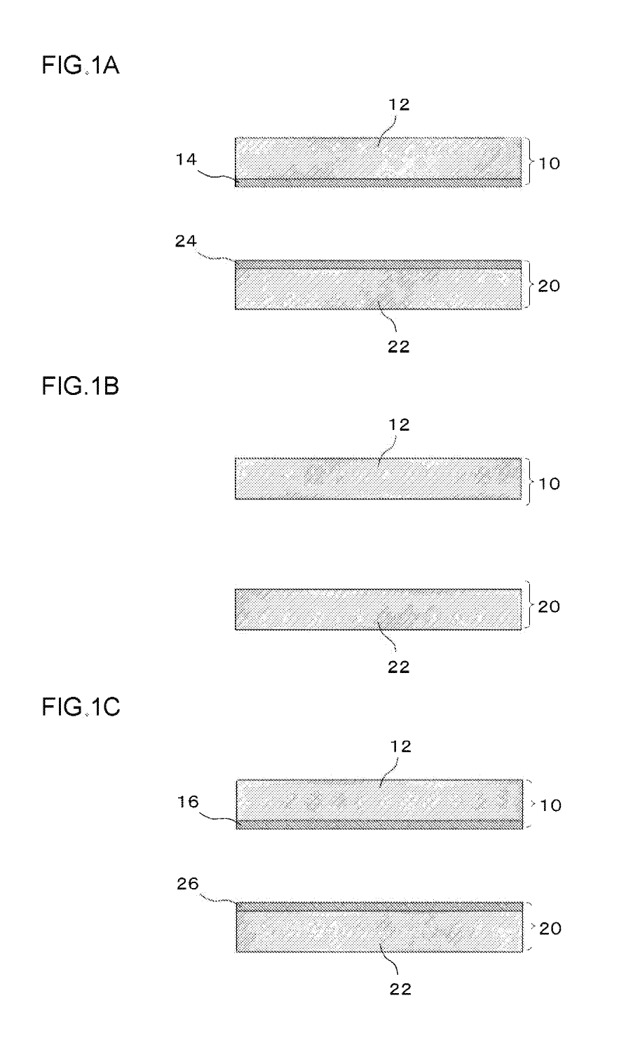

Description will be made below regarding an embodiment of the present invention with reference to the drawings. It should be noted that, in all the drawings, the same components are denoted by the same reference symbols, and redundant description will be omitted as appropriate. FIGS. 1 through 3 are process diagrams showing a metal bonding method according to an embodiment. Referring to FIGS. 1 through 3, description will be made regarding a metal bonding method according to the embodiment.

First, as shown in FIG. 1A, a first bonding portion 10 and a second bonding portion 20 are prepared. The first bonding portion 10 includes a first base portion 12 formed of a metal with Al as a principal component, and a first coating portion 14 configured to coat the surface of the bonding face side of the first base portion 12. Furthermore, the second bonding portion 20 includes a second base member 22 formed of a metal with Al as a principal component, and a second coating portion 24 configured to coat the surface of the bonding face side of the second base portion 22. The first coating portion 14 and the second coating portion 24 are each formed of an oxide material with aluminum oxide as a principal component. Here, “with Al as a principal component” and “with aluminum oxide as a principal component” mean that the material contains aluminum or aluminum oxide with a concentration that is greater than 50%.

Specifically, the first coating portion 14 and the second coating portion 24 are each configured as a thin film formed of Al₂O₃, and each having a thickness of 5 nm, for example. The first coating portion 14 and the second coating portion 24 may each be configured as an artificial coating film or a natural coating film. With the present embodiment, the first coating portion 14 and the second coating portion 24 are each configured as a natural oxide film, which is formed by oxidation of Al in the atmosphere.

Next, as shown in FIG. 1B, the first coating portion 14 and the second coating portion 24 are each removed. Examples of a method for removing the first coating portion 14 and the second coating portion 24 include a method in which reverse sputtering is performed using vacuum equipment. After the first coating portion 14 and the second coating portion 24 are removed, the first base portion 12 and the second base portion 22 each provide a fresh exposed bonding face.

Next, as shown in FIG. 1C, a film formation method such as a sputtering method is used to form a copper film on the bonding faces of the first base portion 12 and the second base portion 22, thereby forming a first copper coating film 16 and a second copper coating film 26. The first copper coating film 16 and the second copper coating film 26 are each configured to have a film thickness of 100 nm, for example.

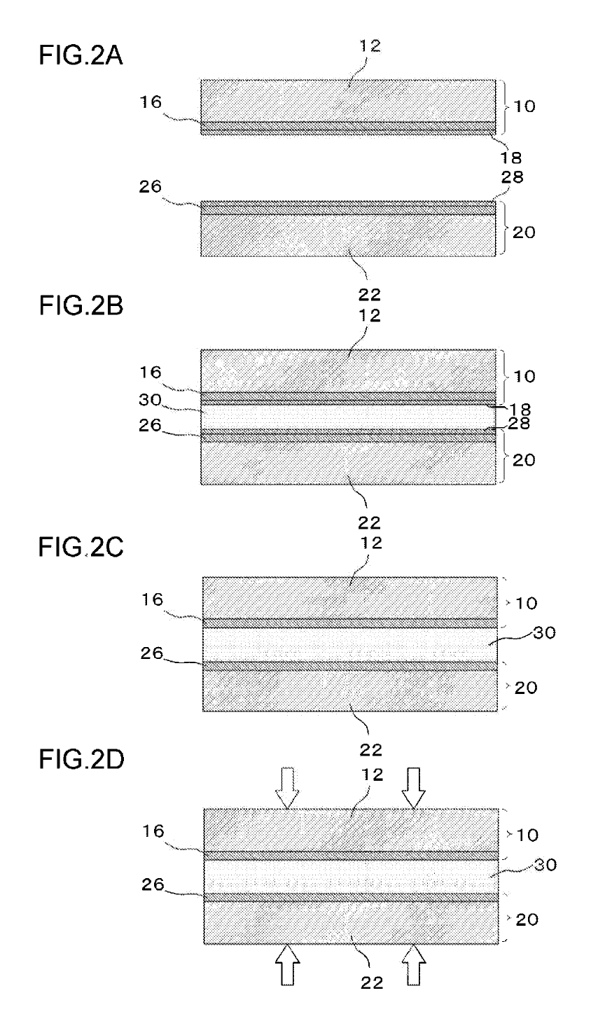

Next, as shown in FIG. 2A, the first bonding portion 10 and the second bonding portion 20 are exposed to the atmosphere. In this stage, the outermost surfaces of the first copper coating film 16 and the second copper coating film 26 are oxidized naturally, thereby providing a first oxide film 18 and a second oxide film 28 each with Cu₂O as a principal component.

Next, as shown in FIG. 2B, the gap between the first oxide film 18 and the second oxide film 28 is filled with a solution 30 into which copper oxide can be eluted or dissolved. With the present embodiment, the solution 30 is configured as ammonia water. In such a stage in which the gap between the first oxide film 18 and the second oxide film 28 is filled with the solution 30, the distance between the exposed face of the first oxide film 18 and the exposed face of the oxide film 28 is 1 to 100 μm, for example.

After the first oxide film 18 and the second oxide film 28 are left for a period of time on the order of 1 minute after the solution 30 is applied to the first oxide film 18 and the second oxide film 28, as shown in FIG. 2C, the copper oxide, which is a component of the first oxide film 18, is eluted into the solution 30, thereby removing the first oxide film 18. In the same way, the copper oxide, which is a component of the second oxide film 28, is eluted into the solution 30, thereby removing the second oxide film 28.

After the copper oxide, which is a component of the first oxide film 18 and the second oxide film 28, is eluted into the solution 30, the first copper coating film 16 and the second copper coating film 26 are respectively exposed as the outermost face (exposed face on the bonding face side) of the first bonding portion 10 and the outermost face (exposed face on the bonding face side) of the second bonding portion 20. Furthermore, a copper complex is generated in the solution 30. With the present embodiment, such a copper complex is considered to be configured as a thermo-degradable tetraamine copper complex ion represented by [Cu(NH₃)₄]²⁺. It should be noted that ammonia water is inactive with respect to copper. Thus, copper, which is a component of the first copper coating film 16 and the second copper coating film 26, does not react with the ammonia water and remains as a component of the respective films.

Next, as shown in FIG. 2D, pressure is applied to the first bonding portion 10 and the second bonding portion 20 by means of a press machine so as to reduce the distance between the first bonding portion 10 and the second bonding portion 20. In the pressing, a pressure of 1 MPa is applied, for example.

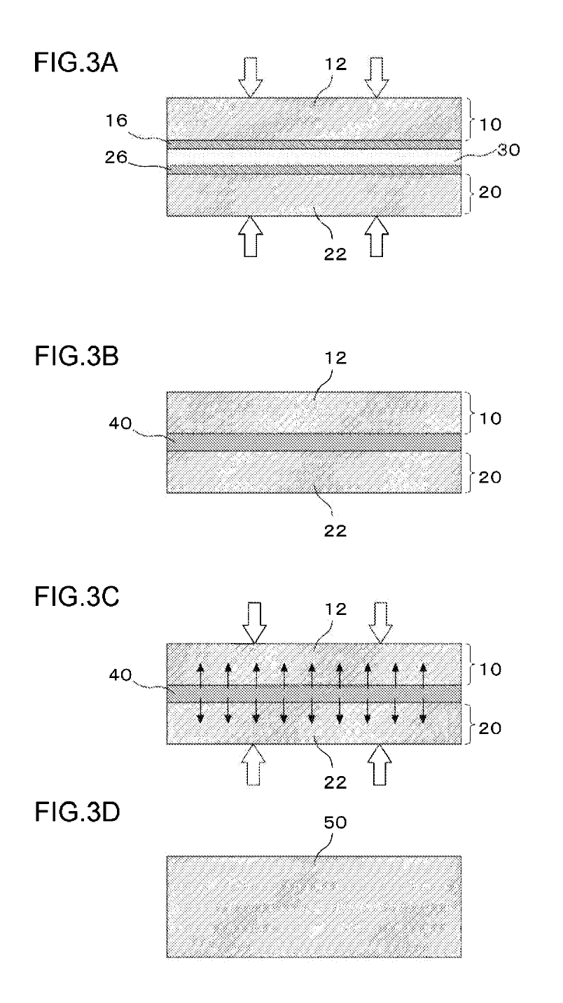

Next, as shown in FIG. 3A, heating is performed at a relatively low temperature of 200° C. to 300° C. in a state in which pressure is applied to the first bonding portion 10 and the second bonding portion 20, so as to encourage solid-phase diffusion of copper to the outermost face (exposed face on the bonding side) of the first bonding portion 10 and the outermost face (exposed face on the bonding side) of the second bonding portion 20. With the present embodiment, the heating provides evaporation of water. Furthermore, the heating provides thermal decomposition of the thermo-degradable tetraamine copper complex ion, thereby providing evaporation of the ammonia component. This gradually increases the concentration of copper contained in the solution 30. Furthermore, pressing by means of the press machine gradually reduces the distance between the outermost face of the first copper coating film 16 and the outermost face of the second copper coating film 26.

Next, as shown in FIG. 3B, after the completion of removal of components contained in the solution 30 except for the copper component, the outermost face of the first copper coating film 16 and the outermost face of the second copper coating film 26 are bonded to each other due to the solid-phase diffusion of copper. Specifically, the copper solid-phase diffusion provides a bonded region 40. The bonded region 40 provided by the solid-phase diffusion exhibits high orientation and high stability. In the final stage, the bonded region 40 provided by the solid-phase diffusion has approximately the same thickness as the sum of the thickness of the first copper coating film 16 and the thickness of the second copper coating film 26, which are each formed in the step shown in FIG. 1C, and the first oxide film 18 and the second oxide film 28 which are each formed in the step shown in FIG. 2A. After the completion of bonding via the bonded region 40 provided by means of the solid-phase diffusion, the heating is stopped, and the bonded portion configured as the bonded region 40 provided by the solid-phase diffusion is cooled until its temperature reaches on the order of room temperature. It should be noted that the period of time from the start of heating up to the stop of heating is 10 minutes, for example. After the cooling, the pressure application is stopped, whereby the bonding step for the first bonding portion 10 and the second bonding portion 20 is completed.

Next, as shown in FIG. 3C, heating and pressure application are performed so as to solid-phase diffuse the bonded region 40 provided by the copper solid-phase diffusion, thereby bonding the first bonding portion 10 and the second bonding portion 20. After the completion of the solid-phase diffusion, finally, as shown in FIG. 3D, the first bonding portion 10 and the second bonding portion 20 are unified, thereby forming a metal member 50.

With the metal bonding method as described above, by providing the first copper coating film 16 and the second copper coating film 26 formed separately, such an arrangement provides high-strength bonding of the first bonding portion 10 and the second bonding portion 20 in a simple manner by means of the first copper coating film 16, the second copper coating film 26, and the bonded region 40 provided by solid-phase diffusion even if the first bonding portion 10 or the second bonding portion 20 has an oxide film formed on its bonding face.

In particular, by removing beforehand the first coating portion 14 formed as the outermost face of the first bonding portion 10 and the second coating portion 24 formed as the outermost face of the second bonding portion 20, such an arrangement provides an activated bonding face on each of the first bonding portion 10 and the second bonding portion 20. As a result, such an arrangement facilitates solid-phase diffusion of the bonded region 40, which was provided by solid-phase diffusion, into the first bonding portion 10 and the second bonding portion 20. Thus, such an arrangement allows the first bonding portion 10 and the second bonding portion to unify without a difference in structure over the region from the first bonding portion 10 to the second bonding portion 20. This raises the reliability of the connection between the first bonding portion and the second bonding portion. It should be noted that, as shown in FIG. 1B, description has been made in the aforementioned embodiment regarding an arrangement in which the natural oxide films are removed. Also, the present invention can be applied to an arrangement in which no oxide film is removed. Specifically, in a case of bonding glass substrates to each other, which is an example in which nonorganic substrates are bonded to each other, the step shown in FIG. 1A is omitted from a series of the bonding process. That is to say, the step shown in FIG. 1B and the subsequent steps should be executed.

Description has been made regarding an arrangement in which the gap between the first oxide film 18 and the second oxide film 28 is filled with a material in the form of a solution. Also, such a material may be provided in the form of a film.

### Application Example 1 of Metal Bonding Method

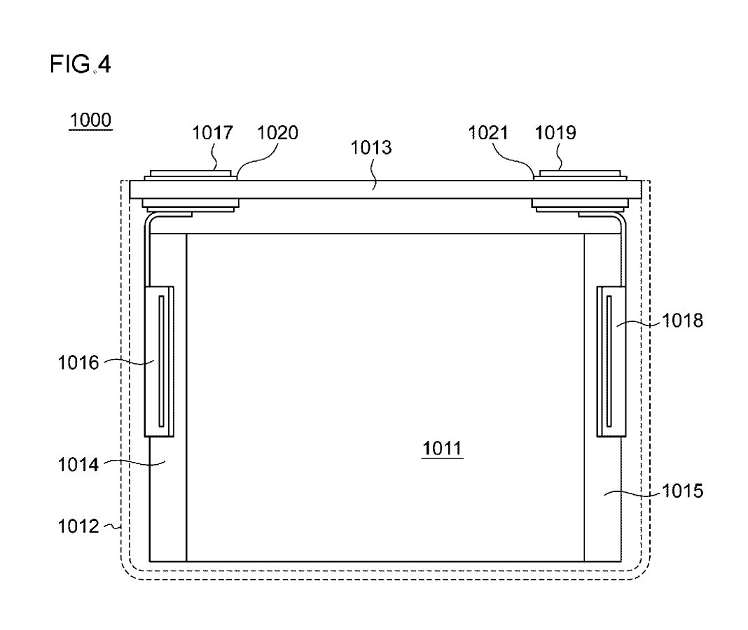

FIG. 4 is a diagram showing a schematic configuration of a conventional non-aqueous electrolyte secondary battery as viewed from the side face. A conventional non-aqueous electrolyte secondary battery 1000 has a configuration in which a wound electrode body 1011, which is configured by winding a positive electrode sheet (not shown) and a negative electrode sheet (not shown) via a separator (not shown), is housed within a battery outer package 1012, and the battery outer package 1012 is sealed by means of a sealing plate 1013.

The wound electrode body 1011 includes a positive electrode core exposed portion 1014 to which no positive-electrode active material is applied and a negative electrode core exposed portion 1015 to which no negative-electrode active material is applied, which are respectively positioned at its respective ends along the winding axis. The positive electrode core exposed portion 1014 is electrically connected to a positive electrode terminal 1017 via a positive electrode collector body 1016. Furthermore, the negative electrode core exposed portion 1015 is electrically connected to a negative electrode terminal 1019 via a negative electrode collector body 1018. The positive electrode core exposed portion 1014 and the positive electrode collector body 1016 are welded to each other in a state in which the positive electrode core exposed portion 1014 is held by the positive electrode collector body 1016. Furthermore, the negative electrode core exposed portion 1015 and the negative electrode collector body 1018 are welded to each other in a state in which the negative electrode core exposed portion 1015 is held by the negative electrode collector body 1018. The positive electrode terminal 1017 and the negative electrode terminal 1019 are fixedly mounted on the sealing plate 1013 via insulating members 1020 and 1021, respectively. After the wound electrode body 1011 is housed within the battery outer package 1012, the sealing plate 1013 is laser-welded to the opening of the battery outer package 1012. Subsequently, a non-aqueous electrolyte solution is injected via an electrolyte solution injecting opening (not shown), and the electrolyte solution injecting opening is sealed, thereby manufacturing the non-aqueous electrolyte secondary battery 1000.

With such a conventional non-aqueous electrolyte secondary battery, in some cases, damage or separation occurs at the connection portion that connects each core exposed portion and the corresponding collector body (extraction electrode) due to corrosion or stress concentration.

The present application is applied to bonding between the core exposed portion and the collector body. Description will be made below regarding the schematic configuration of the process for bonding the core exposed portion and the collector body.

(1) Aluminum oxide that coats the positive electrode core exposed portion and the positive electrode collector body is removed by means of reverse sputtering.

(2) A copper film is formed by means of sputtering on the respective aluminum faces of the positive electrode core exposed portion and the positive electrode collector body, which have been exposed by means of the reverse sputtering.

(3) A positive electrode active material is applied to both faces of the positive electrode core body formed of an aluminum foil, such that it is applied to the positive electrode core exposed portion having a predetermined width along the side orthogonal to the winding axis. Furthermore, a negative electrode active material is applied to both faces of the negative electrode core body formed of a copper foil, such that it is applied to the negative electrode core exposed portion having a predetermined width along the side orthogonal to the winding axis.

(4) The gap between the inner-side positive electrode core exposed portion and the outer-side positive electrode core exposed portion that are in contact with each other after the wound electrode body is formed, the gap between the outer face of the positive electrode core exposed portion and the positive electrode collector body, the gap between the inner-side negative electrode core exposed portion and the outer-side negative electrode core exposed portion that are in contact with each other after the wound electrode body is formed, and the gap between the outer face of the negative electrode core exposed portion and the negative electrode collector body, are each filled with ammonia water.

(5) The outer face of the positive electrode core exposed portion and the positive electrode collector body are pressure bonded while heat is applied. Furthermore, the outer face of the negative electrode core exposed portion and the negative electrode collector body are pressure bonded while heat is applied. This provides a bonding portion formed of copper between the components listed in the aforementioned step (4).

(6) The copper is solid-phase diffused. Thus, the gap between the inner-side positive electrode core exposed portion and the outer-side positive electrode core exposed portion that are in contact with each other after the wound electrode body is formed, and the gap between the outer face of the positive electrode core exposed portion and the positive electrode collector body, are each filled with aluminum containing diffused copper such that they are unified.

With such a bonding method for bonding the core exposed portion and the collector body described above, the positive electrode core exposed portion and the positive electrode collector body are unified via a bonding portion formed of an aluminum-based material. Furthermore, the negative electrode core exposed portion and the negative electrode collector body are unified via a bonding portion formed of a copper-based material. Such an arrangement suppresses stress concentration at the bonding portion that bonds the positive electrode core exposed portion and the positive electrode collector body and at the bonding portion that bonds the negative electrode core exposed portion and the negative electrode collector body, thereby suppressing occurrence of damage or separation at such bonding portions.

### Application Example 2 of Metal Bonding Method

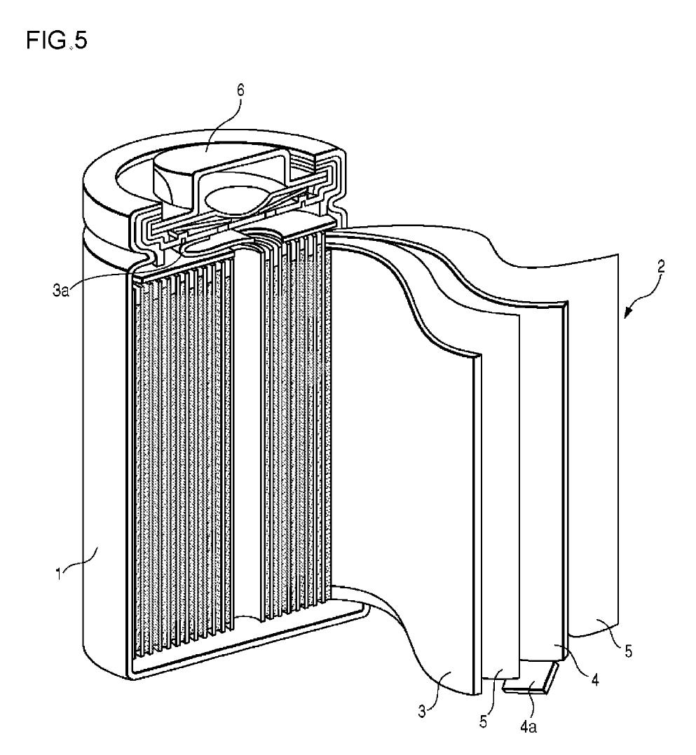

The present application example relates to a bonding method for bonding a collector body and a collector tab included in a cylindrical secondary battery. FIG. 5 is a cross-sectional partial disassembled perspective view showing a cylindrical secondary battery used as an example application. The cylindrical secondary battery has a configuration in which a wound electrode body 2, including a positive electrode sheet 3, a negative electrode sheet 4, and a separator 5, is housed within a cylindrical battery package 1. The opening of the battery package 1 is sealed by means of a sealing member 6. The negative electrode sheet 4 is electrically connected to the battery package 1 via a negative electrode collector tab 4a. Furthermore, the positive electrode sheet 3 is electrically connected to the sealing member 6 via the positive electrode collector tab 3a. That is to say, the battery package 1 also functions as a negative electrode external terminal, and the sealing member 6 also functions as a positive electrode external terminal. Furthermore, a non-aqueous electrolyte is injected into the battery package 1. It should be noted that such a cylindrical secondary battery has the same basic configuration as that of the battery disclosed in Japanese Patent Application Laid Open No. 2011-138633, and detailed description thereof will be omitted.

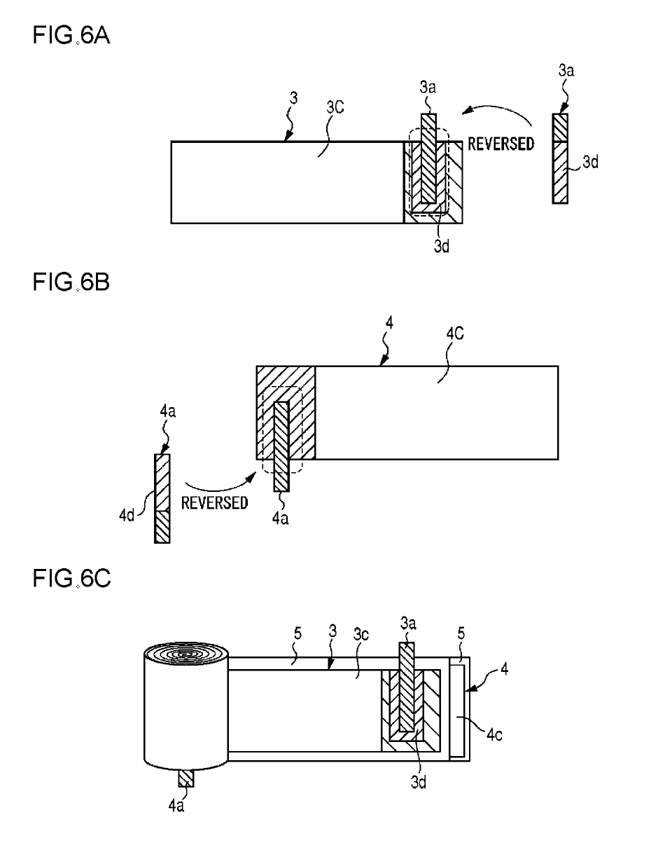

FIG. 6 is a schematic process diagram for describing the application example 2 of the metal bonding method. Description will be made with reference to FIG. 6 regarding the schematic configuration of the process according to the present application example.

(1) A member is prepared by applying a positive electrode active material 3c to both faces of a positive electrode sheet (positive electrode collector body) 3 formed of aluminum foil except for a portion via which a positive electrode collector tab 3a is to be connected (see FIG. 6A).

(2) The positive electrode collector tab 3a formed of aluminum and a predetermined portion of the positive electrode sheet 3 are subjected to reverse sputtering so as to remove aluminum oxide, following which a copper film 3d is formed by means of sputtering (see FIG. 6A).

(3) The positive electrode sheet 3 and the positive electrode collector tab 3a are bonded to each other by solid-phase diffusing the copper, thereby forming a positive electrode (see FIG. 6A).

(4) A member is prepared by applying a negative electrode active material 4c to both faces of a negative electrode sheet (negative electrode collector body) 4 formed of copper foil except for a portion via which a negative electrode collector tab 4a is to be connected (see FIG. 6B).

(5) A predetermined portion of the negative electrode collector tab 4a formed of nickel is subjected to reverse sputtering so as to remove nickel oxide, following which a copper film 4d is formed by means of sputtering (see FIG. 6B).

(6) The negative electrode sheet 4 and the negative electrode collector tab 4a are bonded to each other by solid-phase diffusing the copper, thereby forming a negative electrode (see FIG. 6B).

(7) The positive electrode and the negative electrode thus formed using the aforementioned method are wound via a separator 5 introduced between them, thereby manufacturing a wound electrode body (see FIG. 6C).

With the bonding method for bonding the collector body and the collector tab described above, the positive electrode collector body and the positive electrode collector tab each formed of aluminum are bonded to each other by means of copper solid-phase diffusion. Furthermore, the negative electrode collector body formed of copper and the negative electrode collector tab formed of nickel are bonded to each other by means of copper solid-phase diffusion. Such an arrangement suppresses stress concentration at the bonding portion that bonds the positive electrode collector body and the positive electrode collector tab, and at the bonding portion that bonds the negative electrode collector body and the negative electrode collector tab, thereby suppressing the occurrence of damage or separation at such bonding portions.

### Application Example 3 of Metal Bonding Method

As a conventional heat dissipation structure for a semiconductor package, examples of such a structure include a structure in which a heat sink is thermally connected to a semiconductor element such as an IC chip or the like, and the heat sink is bonded to a heat dissipating fin using a brazing filler metal such as Sn—Ag—Cu solder or the like. With such a conventional heat dissipation structure, in many cases, stress concentration occurs at such a solder bonding portion. In some cases, this leads to a problem of poor strength of the connection between the heat sink and the heat dissipation fin.

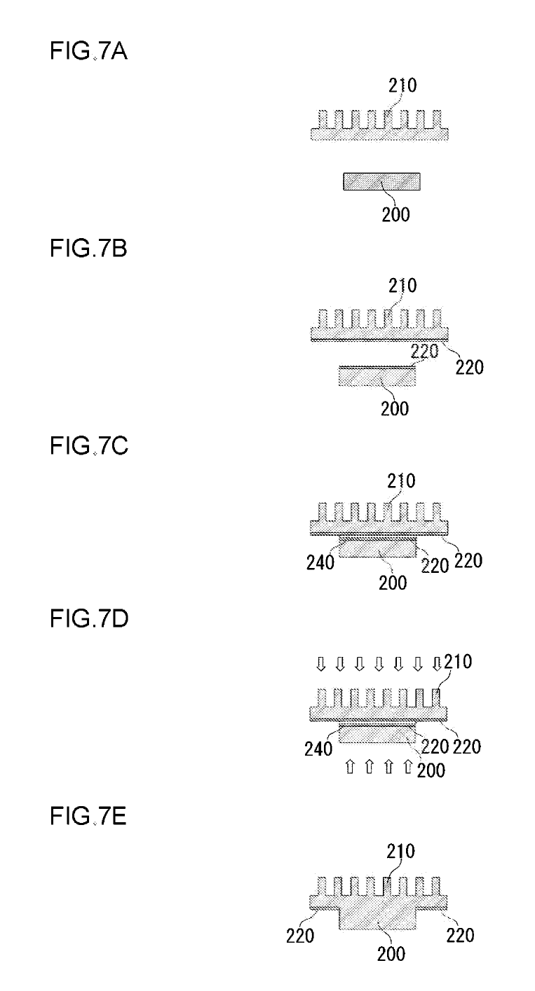

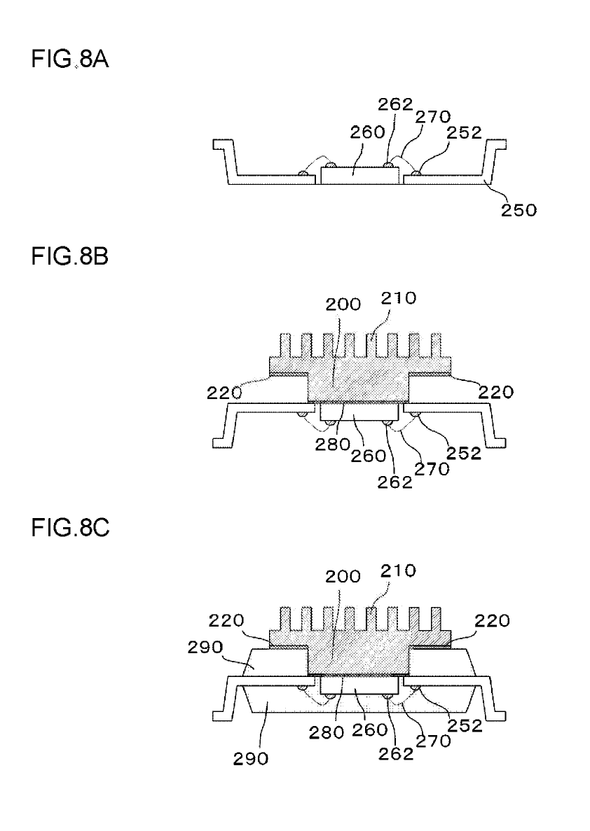

With the present application example, the aforementioned metal bonding method is used to bond a heat sink and a heat dissipation fin. FIGS. 7 and 8 are process diagrams each showing a schematic configuration of a process according to a metal bonding method which is applied to bond a heat sink and a heat dissipation fin.

Specifically, first, as shown in FIG. 7A, a heat sink 200 and a heat dissipation fin 210 are prepared. The heat sink 200 and the heat dissipation fin 210 are each formed of aluminum. Furthermore, the respective bonding faces of the heat sink 200 and the heat dissipation fin 210 are each coated with a natural aluminum oxide (not shown). The aluminum oxide layers that coat the respective bonding faces of the heat sink 200 and the heat dissipation fin 210 are each removed using the reverse sputtering method.

Next, as shown in FIG. 7B, using the sputtering method, a copper film is formed on each of the bonding faces of the heat sink 200 and the heat dissipation fin 210, which were each exposed by removing the aluminum oxide layers so as to expose an aluminum layer, thereby forming copper films 220.

Next, as shown in FIG. 7C, the heat dissipation fin 210 is mounted on the upper part of the heat sink 200 in a state in which the gap between the copper film 220 formed on the bonding face of the heat sink 200 and the copper film 220 formed on the bonding face of the heat dissipation fin 210 is filled with ammonia water 240. It should be noted that, in the stage in which the heat sink 200 and the heat dissipation fin 210 are each exposed to the atmosphere, a copper oxide film is formed on each copper surface.

Next, as shown in FIG. 7D, pressure on the order of 1 MPa is applied to the heat sink 200 and the heat dissipation fin 210 using a press machine. In this state, the heat sink 200 and the heat dissipation fin 210 are heated at 300° C. As a result, the heat sink 200 and the heat dissipation fin 210 are bonded to each other via Cu—Cu bonding. Furthermore, by applying solid-phase diffusion, as shown in FIG. 7E, such an arrangement provides a structure in which the heat sink 200 and the heat dissipation fin 210 are unified.

As another structure that is separate from the aforementioned structure in which the heat sink 200 and the heat dissipation fin 210 are bonded to each other, as shown in FIG. 8A, a semiconductor element 260 is mounted on a lead frame 250, and electrode pads 252 provided to the lead frame 250 are respectively connected to element electrodes 262 of the semiconductor element 260 by means of wire bonding using a gold wire 270.

Next, as shown in FIG. 8B, the heat sink 200 is adhered, using an adhesive member 280 such as an adhesive tape or the like, to the face of the semiconductor element 260 that is opposite to the face on which the electrodes are formed.

Next, as shown in FIG. 8C, the semiconductor element 260 is sealed using sealing resin 290.

By executing the aforementioned steps, such an arrangement provides a semiconductor package having a heat dissipating structure in which the heat sink 200 and the heat dissipation fin 210 are monolithically formed. The bonded portion between the heat sink 200 and the heat dissipation fin 210 is formed of the same material as that of the heat sink 200 and the heat dissipation fin 210. Thus, such an arrangement suppresses stress concentration that occurs between the heat sink 200 and the heat dissipation fin 210. This provides improved strength of the bonding between the heat sink 200 and the heat dissipation fin 210.

### [Solution Used for Metal Bonding]

With the metal bonding method according to the aforementioned embodiment, ammonia water is used as a solution to be used for metal bonding. However, the present invention is not restricted to such an arrangement. Rather, a desired solution may be employed provided that the solution contains a ligand that can form a complex with copper. Examples of such a solution include a carboxylic acid aqueous solution.

Examples of carboxylic acids used to prepare such a carboxylic acid aqueous solution include: monocarboxylic acid such as acetic acid, and the like; dicarboxylic acid such as oxalic acid, malonic acid, succinic acid, glutaric acid, phthalic acid, maleic acid, and the like; and oxycarboxylic acid such as tartaric acid, citric acid, lactic acid, salicylic acid, and the like.

With such an arrangement, such a carboxylic acid aqueous solution preferably contains carboxylic acid which is able to function as a multidentate ligand. With such a carboxylic acid aqueous solution containing carboxylic acid which is able to function as a multidentate ligand, the carboxylic acid and copper form a chelate, thereby generating a copper complex having markedly improved stability. As a result, such an arrangement is capable of reducing the temperature required for the bonding. It should be noted that the fact that tartaric acid forms a chelate is described in “The Iwanami Dictionary of Physics and Chemistry”, 4th ed., p. 593 (Iwanami Shoten). Also, the fact that tartaric acid, oxalic acid, or the like, forms a chelate is described in “Inorganic chemistry”, Vol. 2, p. 666, written by R. B. Heslop, K. Jones, translated by Yoshihiko Saito. Here, chelation represents a reaction in which a multidentate ligand forms a ring, thereby generating a complex having markedly improved stability.

The present invention is not restricted to the aforementioned embodiment. Also, various kinds of modifications such as design modifications may be made based on the knowledge of those skilled in this art, which are also encompassed within the technical scope of the present invention.

For example, description has been made in the aforementioned embodiment regarding an arrangement in which the first bonding portion 10 and the second bonding portion 20 are formed of the same metal material, i.e., aluminum. Also, the second bonding portion 20 may be formed of a metal material that differs from a metal material that forms the first bonding portion 10. For example, an arrangement may be made in which the first bonding portion 10 is formed of Al, and the second bonding portion 20 is formed of Au, thereby providing an Al—Au clad material. It should be noted that the second bonding portion 20 may be formed of Ti, Ta, or the like, instead of Au.

Description has been made in the aforementioned embodiment regarding an arrangement in which heating is performed in a state in which the first bonding portion 10 and the second bonding portion 20 are pressed in contact with each other. Also, such heating may be performed before or otherwise after the first bonding portion 10 and the second bonding portion 20 are pressed in contact with each other. It should be noted that the application of pressure is indispensable to the bonding of the first bonding portion 10 and the second bonding portion 20. However, the heating may be omitted. For example, by applying pressure to the first bonding portion 10 and the second bonding portion 20 at an ordinary temperature in a low-pressure environment, such an arrangement is capable of bonding the first bonding portion 10 and the second bonding portion 20.

It should be noted that the invention according to the present embodiment may be specified according to the items described below.

[Item 1] A metal bonding method comprising:

preparing a first bonding portion containing, as a principal component, a metal component other than copper or an inorganic compound, and a second bonding portion containing, as a principal component, a metal component that is the same as or otherwise differs from the metal component that is a principal component of the first bonding portion;

forming a copper film on an exposed face of the first bonding portion and on an exposed face of the second bonding portion;

filling a gap between the copper film formed on the first bonding portion and the copper film formed on the second bonding portion with a material into which copper oxide can be eluted; and

applying pressure to the first bonding portion and the second bonding portion so as to reduce the distance between them, thereby bonding the first bonding portion and the second bonding portion via copper.

[Item 2] A metal bonding method according to Item 1, further comprising heating the first bonding portion and the second bonding portion before pressure is applied to the first bonding portion and the second bonding portion, during a period of time in which pressure is applied to the first bonding portion and the second bonding portion, or otherwise after pressure is applied to the first bonding portion and the second bonding portion.
[Item 3] A metal bonding method according to Item 1 or 2, further comprising removing an oxide film from the outermost face of the first bonding portion and from the outermost face of the second bonding portion before a copper film is formed on the exposed face of the first bonding portion and on the exposed face of the second bonding portion.
[Item 4] A metal bonding method according to Item 3, further comprising solid-phase diffusing copper that bonds the first bonding portion and the second bonding portion into the first bonding portion and the second bonding portion.
[Item 5] A metal bonding method according to any one of Items 1 through 4, wherein the aforementioned material is inactive with respect to copper.
[Item 6] A metal bonding method according to any one of Items 1 through 5, wherein the aforementioned material contains a ligand that forms a complex with copper.
[Item 7] A metal bonding method according to Item 6, wherein the aforementioned complex is thermally degradable.
[Item 8] A metal bonding method according to any one of Items 1 through 7, wherein the aforementioned material is configured as ammonia water or otherwise as a carboxylic acid aqueous solution.
[Item 9] A metal bonding method according to Item 8, wherein carboxylic acid contained in the aforementioned carboxylic acid aqueous solution functions as a multidentate ligand.

What is claimed is:

1. A metal bonding method comprising:
preparing a first bonding portion containing, as a principal component, a metal component other than copper or an inorganic compound, and a second bonding portion containing, as a principal component, a metal component that is the same as or otherwise differs from the metal component that is a principal component of the first bonding portion;
forming a copper film on an exposed face of the first bonding portion and on an exposed face of the second bonding portion;
filling a gap between the copper film formed on the first bonding portion and the copper film formed on the second bonding portion with a material into which copper oxide can be eluted; and
applying pressure to the first bonding portion and the second bonding portion so as to reduce the distance between them, thereby bonding the first bonding portion and the second bonding portion via copper.

2. A metal bonding method according to claim 1, further comprising heating the first bonding portion and the second bonding portion before pressure is applied to the first bonding portion and the second bonding portion, during a period of time in which pressure is applied to the first bonding portion and the second bonding portion, or otherwise after pressure is applied to the first bonding portion and the second bonding portion.

3. A metal bonding method according to claim 1, further comprising removing an oxide film from the outermost face of the first bonding portion and from the outermost face of the second bonding portion before a copper film is formed on the exposed face of the first bonding portion and on the exposed face of the second bonding portion.

4. A metal bonding method according to claim 2, further comprising removing an oxide film from the outermost face of the first bonding portion and from the outermost face of the second bonding portion before a copper film is formed on the exposed face of the first bonding portion and on the exposed face of the second bonding portion.

5. A metal bonding method according to claim 3, further comprising solid-phase diffusing copper that bonds the first bonding portion and the second bonding portion into the first bonding portion and the second bonding portion.

6. A metal bonding method according to claim 4, further comprising solid-phase diffusing copper that bonds the first bonding portion and the second bonding portion into the first bonding portion and the second bonding portion.

7. A metal bonding method according to claim 1, wherein the aforementioned material is inactive with respect to copper.

8. A metal bonding method according to claim 2, wherein the aforementioned material is inactive with respect to copper.

9. A metal bonding method according to claim 1, wherein the aforementioned material contains a ligand that forms a complex with copper.

10. A metal bonding method according to claim 2, wherein the aforementioned material contains a ligand that forms a complex with copper.

11. A metal bonding method according to claim 9, wherein the aforementioned complex is thermally degradable.

12. A metal bonding method according to claim 10, wherein the aforementioned complex is thermally degradable.

13. A metal bonding method according to claim 1, wherein the aforementioned material is configured as ammonia water or otherwise as a carboxylic acid aqueous solution.

14. A metal bonding method according to claim 2, wherein the aforementioned material is configured as ammonia water or otherwise as a carboxylic acid aqueous solution.

15. A metal bonding method according to claim 13, wherein carboxylic acid contained in the aforementioned carboxylic acid aqueous solution functions as a multidentate ligand.

16. A metal bonding method according to claim 14, wherein carboxylic acid contained in the aforementioned carboxylic acid aqueous solution functions as a multidentate ligand.
